(19) United States
(12) Patent Application Publication
(10) Pub. No.: US 2020/0039822 A1
(43) Pub. Date: Feb. 6, 2020

(54) HYDROGEN PEROXIDE COMPOSITION AND METHOD FOR PRODUCING CHLORINE DIOXIDE

(71) Applicant: Evonik Corporation, Parsippany, NJ (US)

(72) Inventors: Gregory Melenkevitz, Union, NJ (US); Gerhard Arnold, Ringwood, NJ (US); Larry Vail, Tappan, NY (US)

(73) Assignee: Evonik Corporation, Parsippany, NJ (US)

(21) Appl. No.: 16/340,239

(22) PCT Filed: Sep. 28, 2017
(86) PCT No.: PCT/US2017/053872

§ 371 Date: Apr. 8, 2019

Related U.S. Application Data
(60) Provisional application No. 62/407,649, filed on Oct. 13, 2016.
(60) Provisional application No. 62/465,245, filed on Mar. 1, 2017.

(51) Int. Cl. C01B 11/02; C01B 15/013

(52) U.S. Cl. CPC C01B 11/026; C01B 15/013

(57) ABSTRACT

The use of a single phase aqueous hydrogen peroxide composition, comprising from 5 to 75% by weight of hydrogen peroxide and from 3 to 150 mg/kg of at least one alkyl phosphate, the composition having a total organic carbon content from organic compounds other than alkyl phosphates of less than 200 mg/kg, reduces foam formation in a method for producing chlorine dioxide by reacting an alkali chlorate with hydrogen peroxide composition in an acidic aqueous medium boiling at sub-atmospheric pressure.

### FIELD OF THE INVENTION

The invention relates to an aqueous hydrogen peroxide composition for producing chlorine dioxide and to a method for producing chlorine dioxide that uses the aqueous hydrogen peroxide composition.

### BACKGROUND OF THE INVENTION

Chlorine dioxide is widely used for delignifying cellulose pulp and is produced at pulp mill sites by reducing sodium chlorate with methanol, sulfur dioxide or hydrogen peroxide as the reductant. The use of hydrogen peroxide as reductant has the advantage of providing chlorine dioxide with a low content of elemental chlorine at a high production rate.

U.S. Pat. Nos. 5,091,166 and 5,091,167 disclose a method for producing chlorine dioxide by reacting an alkali metal chlorate with hydrogen peroxide in a single vessel generator-evaporator-crystallizer unit at sub-atmospheric pressure. This method has found wide use in pulp mills, but the chlorine dioxide production rate of these units is often limited by foam formation in the unit, which can lead to chlorine dioxide decomposition forcing a shut-down of the unit.

U.S. Pat. No. 5,366,714 teaches that foam formation can be avoided by pre-mixing hydrogen peroxide with the aqueous chlorate solution or a strong mineral acid fed to a chlorine dioxide generator operated at sub-atmospheric pressure.

U.S. Pat. No. 6,576,213 teaches to use a hydrogen peroxide stabilized with 0.1 to 10 g/l of a phosphonic acid and containing less than 15 mg Sn per kg H₂O₂ for reducing foam formation during production of chlorine dioxide to an acceptable level by maintaining the content of tin in the reaction medium below 20 mg Sn per kg reaction medium.

### SUMMARY OF THE INVENTION

The inventors of the current invention have now found that foam formation during chlorine dioxide production can be prevented by using a hydrogen peroxide with low levels of organic impurities containing a dissolved alkyl phosphate, such as tri-n-butyl phosphate.

Subject of the invention is therefore a single phase aqueous hydrogen peroxide composition for producing chlorine dioxide, comprising from 5 to 75% by weight of hydrogen peroxide and from 3 to 150 mg/kg of at least one alkyl phosphate, the composition having a total organic carbon content from organic compounds other than said alkyl phosphates of less than 200 mg/kg.

A further subject of the invention is a method for producing chlorine dioxide, wherein an alkali chlorate is reacted with the aqueous hydrogen peroxide composition of the invention in an acidic aqueous medium boiling at sub-atmospheric pressure.

### DETAILED DESCRIPTION OF THE INVENTION

The aqueous hydrogen peroxide composition of the invention comprises from 5 to 75% by weight of hydrogen peroxide. The hydrogen peroxide content is preferably from 25 to 75% by weight and more preferably from 30 to 70% by weight.

The aqueous hydrogen peroxide composition of the invention comprises at least one alkyl phosphate and the total amount of alkyl phosphates in the composition is from 3 to 150 mg/kg. The alkyl phosphate preferably comprises alkyl groups containing from 3 to 10 carbon atoms. The alkyl phosphate may be a monoalkylphosphate, a dialkylphosphate, a trialkylphosphate or a mixture of any two or three of these. Preferably, at least 90% by weight of the alkyl phosphates are selected from tri-n-butyl phosphate and tri-iso-butyl phosphate. In a preferred embodiment, the aqueous hydrogen peroxide composition of the invention comprises from 25 to 75% by weight of hydrogen peroxide and from 10 to 90 mg/kg tri-n-butyl phosphate or tri-iso-butyl phosphate. The alkyl phosphate contained in the aqueous hydrogen peroxide composition of the invention suppresses foam formation when the composition is used for producing chlorine dioxide. Compared to other defoamers, alkyl phosphates have the advantage of being stable to oxidation by hydrogen peroxide and the aqueous hydrogen peroxide composition of the invention therefore provides low foaming in chlorine dioxide production even after long periods of storage.

The aqueous hydrogen peroxide composition of the invention is a single phase composition, i.e. the alkyl phosphate is dissolved in the aqueous phase and the composition does not comprise a dispersed organic phase. For alkyl phosphates having a solubility of less than 150 mg/kg in the aqueous hydrogen peroxide, the maximum content of alkyl phosphates in the aqueous hydrogen peroxide composition of the invention is therefore limited by the solubility of the alkyl phosphate. Compared to a composition containing an emulgated liquid defoamer, the single phase composition of the invention has the advantage that the content of the defoaming alkyl phosphate will not change over time as a result of phase separation. In addition, the single phase composition can avoid safety risks associated with an emulsion containing more than 40% by weight hydrogen peroxide in the aqueous phase, where creaming of the emulsion may lead to concentrating the organic phase to a degree where the mixture of organic material and hydrogen peroxide gets explosive.

The aqueous hydrogen peroxide composition of the invention has a total organic carbon content (TOC) from organic compounds other than alkyl phosphates of less than 200 mg/kg, preferably less than 100 mg/kg and more preferably less than 50 mg/kg. A low TOC from organic compounds other than alkyl phosphates provides a better solubility of the alkyl phosphate in the composition and allows for providing a higher concentration of alkyl phosphate in a homogeneous composition, which provides better foam reduction when the composition is used for producing chlorine dioxide.

In a preferred embodiment, the aqueous hydrogen peroxide composition of the invention is prepared by subjecting an aqueous hydrogen peroxide solution to reverse osmosis to provide a permeate with a total organic carbon content of less than 200 mg/kg, preferably less than 100 mg/kg and more preferably less than 50 mg/kg, followed by adding at least one alkyl phosphate to said permeate. A composition of the invention prepared this way provides particularly low foaming in chlorine dioxide production, which the inventors believe to be due to removing impurities from the hydrogen peroxide by reverse osmosis which promote foam formation in chlorine dioxide production.

The aqueous hydrogen peroxide composition of the invention may contain one or more peroxide stabilizers which stabilize the composition to hydrogen peroxide decomposition during storage. The peroxide stabilizer may be a metal chelating agent, such as a chelating phosphonic acid or phosphonic acid salt. Examples of suitable chelating phosphonic acids are 1-hydroxyethylidene-1,1-diphosphonic acid (HEDP), aminotris(methylenephosphonic acid) (ATMP), ethylenediamine tetra(methylene phosphonic acid) (EDTMP) and diethylenetriamine penta(methylene phosphonic acid) (DTPMP). The peroxide stabilizer may also be a tin containing peroxide stabilizer, which may be used alone or in combination with a metal chelating agent. The aqueous hydrogen peroxide composition of the invention preferably comprises at least one tin-containing peroxide stabilizer in an amount of from 1 to 20 mg/I tin, more preferably from 1 to 20 mg/I tin. The tin-containing peroxide stabilizer is preferably sodium stannate. In a preferred embodiment, the aqueous hydrogen peroxide composition of the invention comprises sodium stannate as a stabilizer and no phosphonic acid or phosphonate salt. When the composition of the invention is prepared by reverse osmosis and addition of an alkyl phosphate to the permeate, the peroxide stabilizer is preferably added to the permeate, either before or after addition of then alkyl phosphate.

The aqueous hydrogen peroxide composition of the invention may further comprise inorganic phosphate, preferably in an amount of from 5 to 100 mg/kg calculated as PO₄³⁻. The inorganic phosphate may be phosphoric acid or a salt thereof, such as sodium dihydrogenphosphate. The inorganic phosphate may be also be pyrophosphoric acid or a salt thereof, such as disodium dihydrogenpyrophosphate. The aqueous hydrogen peroxide composition of the invention may comprise both phosphoric acid and sodium dihydrogenphosphate.

The aqueous hydrogen peroxide composition of the invention is useful for producing chlorine dioxide by reacting an alkali chlorate with the aqueous hydrogen peroxide composition at sub-atmospheric pressure, because the use of the composition of the invention reduces foam formation in such a process.

In the method of the invention for producing chlorine dioxide, an alkali chlorate is reacted with an aqueous hydrogen peroxide composition of the invention in an acidic aqueous medium boiling at sub-atmospheric pressure.

The alkali chlorate is reacted with the aqueous hydrogen peroxide composition of the invention in an acidic aqueous medium. Preferably, the aqueous hydrogen peroxide composition of the invention and an aqueous alkali chlorate solution are added to the acidic aqueous medium at a rate corresponding to the formation of chlorine dioxide, maintaining a chlorate concentration in the acidic aqueous medium of from 0.1 mol/1 up to saturation, preferably from 2.5 mol/1 up to saturation. The aqueous hydrogen peroxide composition of the invention and the aqueous alkali chlorate solution are preferably added at a molar ratio of chlorate to hydrogen peroxide of from 1.8:1 to 2.0:1, more preferably 1.9:1 to 2.0:1. The aqueous hydrogen peroxide composition of the invention may be mixed with an aqueous alkali chlorate solution before it is added to the acidic aqueous medium. The alkali chlorate is preferably sodium chlorate or potassium chlorate and most preferably sodium chlorate.

The acidic aqueous medium preferably has an acidity of from 0.5 to 14 N, more preferably 1 to 12 N and most preferably 2 to 5 N. The acidity is preferably provided by adding sulfuric acid. The alkali chlorate is reacted with the aqueous hydrogen peroxide composition at sub-atmospheric pressure, preferably at a pressure of from 10,000 to 80,000 Pa, more preferably from 10,000 to 40,000 Pa. The reaction is carried out at the temperature at which the acidic aqueous medium boils at the sub-atmospheric pressure employed. The method of the invention thus provides a vapor phase, containing the chlorine dioxide and oxygen produced and vaporized water, from which vapor phase an aqueous solution of chlorine dioxide can be condensed or chlorine dioxide can be absorbed into water.

The method of the invention for producing chlorine dioxide is preferably carried out continuously, feeding an aqueous alkali chlorate solution, an aqueous hydrogen peroxide composition of the invention and a mineral acid to a chlorine dioxide generator containing the acidic aqueous medium boiling at sub-atmospheric pressure. The aqueous hydrogen peroxide composition of the invention may be combined with the aqueous alkali chlorate solution before feeding it to the chlorine dioxide generator. Preferably, the volume of acidic aqueous medium present in the chlorine dioxide generator is kept essentially constant by continuously withdrawing acidic aqueous medium from the chlorine dioxide generator.

The continuous reaction is preferably carried out in a unit comprising a single vessel generator, an evaporator and a crystallizer. The reaction is then preferably carried out using sodium chlorate as the alkali chlorate and sulfuric acid as the mineral acid and sodium sulfate, sodium sesquisulfate or sodium hydrogensulfate is crystallized in the crystallizer. The evaporator is preferably operated to maintain an essential constant hold up of liquid in the unit. Suitable units are commercially available, for example under the trade name SVP® from Eka. Suitable operating conditions for such a unit are known from the prior art, such as from U.S. Pat. Nos. 5,091,166 and 5,091,167.

The method of the invention which uses a hydrogen peroxide containing an alkyl phosphate has the advantage that less foam is formed during the reaction compared to using a hydrogen peroxide which does not contain an alkyl phosphate. Excessive foam formation causes fluctuations in the liquid level of the reaction mixture, which leads to unstable operation of the chlorine dioxide generator that may cause a decomposition of chlorine dioxide in the vapor phase requiring a shutdown of the chlorine dioxide generator. The production capacity of a chlorine dioxide generator is therefore usually limited by foam formation and the method of the invention allows for increasing the output of a chlorine dioxide generator. Foaming may also lead to a carryover of droplets of the acidic aqueous medium, in which the reaction is carried out, to downstream equipment, which lowers the chlorine dioxide yield and can lead to corrosion problems in downstream equipment. The method of the invention therefore also reduces corrosion problems in downstream equipment over prior art methods using a hydrogen peroxide which does not contain an alkyl phosphate. The method of the invention also reduces foam formation compared to a method where the same amount of an alkyl phosphate is added to the acidic aqueous medium separately from the hydrogen peroxide.

### EXAMPLES

### Example 1

A SVP® chlorine dioxide generator from Eka was operated in a paper mill at a pressure of about 350 mbar feeding a 680 g/l sodium chlorate solution, 50% by weight hydrogen peroxide, 93% by weight sulfuric acid and water at volumetric ratios of about 100:20:26:33, combining the sulfuric acid and water before feeding it to the chlorine dioxide generator. When hydrogen peroxide containing about 400 mg/l ATMP, about 250 mg/l inorganic phosphate and about 200 mg/l nitrate and having a total organic carbon content of about 200-400 ppm was used, the chlorine dioxide generator could be operated at an output rate of 40 to 42 tons chlorine dioxide per day. The output rate was limited by foaming of the reaction medium at higher output rates.

When a hydrogen peroxide containing about 50 mg/l DTPMP, about 75 mg/l sodium stannate and about 100 mg/l inorganic phosphate, about 150 mg/l nitrate and having a total organic carbon content of about 500 to 1000 ppm was used at the same operating conditions, the chlorine dioxide generator could be operated at an output rate of up to 38 tons chlorine dioxide per day.

When tri-n-butyl phosphate was added to the chlorine dioxide generator at a rate of 0.35 ml/min, using the same hydrogen peroxide and operating conditions, the chlorine dioxide generator could be operated at an output rate of 38 to 41 tons chlorine dioxide per day.

When a hydrogen peroxide containing no organic stabilizer, about 10 mg/l sodium stannate, about 50 mg/l inorganic phosphate and about 30 mg/l tri-n-butyl phosphate and having a total organic carbon content of less than 100 ppm was used at the same operating conditions, the chlorine dioxide generator could be operated at an output rate of up to 51 tons chlorine dioxide per day.

The example demonstrates that the use of an aqueous hydrogen peroxide composition of the invention allowed to operate the chlorine dioxide generator at a higher output rate compared to using a hydrogen peroxide with a low tin content as disclosed in U.S. Pat. No. 6,576,213 or adding tri-n-butyl phosphate separately from the hydrogen peroxide.

### Example 2

Solubility of tri-n-butyl phosphate in aqueous hydrogen peroxide was determined at 5° C. by magnetically stirring a 500 g sample and adding tri-n-butyl phosphate in increments of 5 or 10 μl. Stirring was stopped after 1, 5, 15 and 30 min and a further increment was added when no undissolved tri-n-butyl phosphate was visible. Samples 1 to 4 were prepared from a 70% by weight unstabilized hydrogen peroxide with a total organic carbon content of less than 50 mg/kg.

Sample 1 was stabilized with 7 mg/kg sodium stannate and 55 mg/kg # phosphate. A clear solution was observed after addition of 45 μl of tri-n-butyl phosphate and undissolved tri-n-butyl phosphate was observed after adding a further 5 μl increment, corresponding to a solubility of about 93 mg/kg.

Sample 2 was diluted to 50% by weight and stabilized with 5 mg/kg sodium stannate and 20 mg/kg # phosphate. A clear solution was observed after addition of 70 μl of tri-n-butyl phosphate and undissolved tri-n-butyl phosphate was observed after adding a further 5 μl increment, corresponding to a solubility of about 140 mg/kg.

Sample 3 was diluted to 50% by weight and stabilized with 400 mg/kg DTPMP. A clear solution was observed after addition of 35 μl of tri-n-butyl phosphate and undissolved tri-n-butyl phosphate was observed after adding a further 5 μl increment, corresponding to a solubility of about 73 mg/kg.

Sample 4 was diluted to 50% by weight and stabilized with 420 mg/kg DTPMP, 24 mg/kg # phosphate and 100 mg/kg sodium nitrate. A clear solution was observed after addition of 45 μl of tri-n-butyl phosphate and undissolved tri-n-butyl phosphate was observed after adding a further 5 μl increment, corresponding to a solubility of about 93 mg/kg.

Sample 5 was a 50% by weight hydrogen peroxide with a total organic carbon content of about 500 mg/kg stabilized with 40 mg/kg sodium stannate, 40 mg/kg # organic stabilizer # and 40 mg/kg # phosphate. A clear solution was observed after addition of 45 μl of tri-n-butyl phosphate and undissolved tri-n-butyl phosphate was observed after adding a further 5 μl increment, corresponding to a solubility of about 93 mg/kg.

The results for samples 2 to 5 demonstrate that high contents of organic impurities or organic phosphonate stabilizers reduce the solubility of tri-n-butyl phosphate in aqueous hydrogen peroxide. The results for samples 1 and 2 demonstrate that the solubility of tri-n-butyl phosphate in aqueous hydrogen peroxide decreases with increasing hydrogen peroxide concentration.

1. A single phase aqueous hydrogen peroxide composition for producing chlorine dioxide, comprising
from 5 to 75% by weight of hydrogen peroxide, and
from 3 to 150 mg/kg of at least one alkyl phosphate;
the composition having a total organic carbon content from organic compounds other than said alkyl phosphates of less than 200 mg/kg.

2. The aqueous hydrogen peroxide composition of claim 1, prepared by subjecting an aqueous hydrogen peroxide solution to reverse osmosis to provide a permeate with a total organic carbon content of less than 200 mg/kg, and adding at least one alkyl phosphate to said permeate.

3. The aqueous hydrogen peroxide composition of claim 1, wherein the alkyl phosphates comprise alkyl groups containing from 3 to 10 carbon atoms.

4. The aqueous hydrogen peroxide composition of claim 1, wherein at least 90% by weight of said alkyl phosphates are selected from tri-n-butyl phosphate and tri-iso-butyl phosphate.

5. The aqueous hydrogen peroxide composition of claim 4, comprising from 25 to 75% by weight of hydrogen peroxide and from 10 to 90 mg/kg tri-n-butyl phosphate.

6. The aqueous hydrogen peroxide composition of claim 4, comprising from 25 to 75% by weight of hydrogen peroxide and from 10 to 90 mg/kg tri-iso-butyl phosphate.

7. The aqueous hydrogen peroxide composition of claim 1, further comprising at least one tin-containing peroxide stabilizer in an amount of from 1 to 20 mg/I tin.

8. The aqueous hydrogen peroxide composition of claim 7, wherein said tin-containing peroxide stabilizer is sodium stannate.

9. The aqueous hydrogen peroxide composition of claim 1, further comprising inorganic phosphate in an amount of from 5 to 100 mg/kg calculated as PO₄³⁻.

10. The aqueous hydrogen peroxide composition of claim 1, having a total organic carbon content from organic compounds other than said alkyl phosphates of less than 50 mg/kg.

11. A method for producing chlorine dioxide, wherein an alkali chlorate is reacted with an aqueous hydrogen peroxide composition according to any one of claim 1 in an acidic aqueous medium boiling at sub-atmospheric pressure.

12. The method of claim 11, wherein the pressure is from 10,000 to 80,000 Pa.

13. The method of claim 11, wherein the alkali chlorate is reacted continuously with said aqueous hydrogen peroxide composition in a unit comprising a single vessel generator, an evaporator and a crystallizer.

14. The method of claim 11, wherein said hydrogen peroxide composition is mixed with an aqueous alkali chlorate solution before adding it to said acidic aqueous medium.

15. The aqueous hydrogen peroxide composition of claim 2, wherein the alkyl phosphates comprise alkyl groups containing from 3 to 10 carbon atoms.

16. The aqueous hydrogen peroxide composition of claim 2, wherein at least 90% by weight of said alkyl phosphates are selected from tri-n-butyl phosphate and tri-iso-butyl phosphate.

17. The method of claim 12, wherein the alkali chlorate is reacted continuously with said aqueous hydrogen peroxide composition in a unit comprising a single vessel generator, an evaporator and a crystallizer.

18. The aqueous hydrogen peroxide composition of claim 2, further comprising at least one tin-containing peroxide stabilizer in an amount of from 1 to 20 mg/I tin.

19. The aqueous hydrogen peroxide composition of claim 2, further comprising inorganic phosphate in an amount of from 5 to 100 mg/kg calculated as PO₄³⁻.

20. The aqueous hydrogen peroxide composition of claim 2, having a total organic carbon content from organic compounds other than said alkyl phosphates of less than 50 mg/kg.
